(19) United States
(12) Patent Application Publication
(10) Pub. No.: US 2009/0202836 A1
(43) Pub. Date: Aug. 13, 2009

(54) METHODS OF FORMING A BARRIER

(75) Inventors: John Lindley Bancroft, Cheshire (GB); James Rolfe, Cheshire (GB)

Correspondence Address: KING & SCHICKLI, PLLC, 247 NORTH BROADWAY, LEXINGTON, KY, 40507, US

(73) Assignee: Novel Polymer Solutions Ltd.

(21) Appl. No.: 11/996,834

(22) PCT Filed: Jul. 26, 2006
(86) PCT No.: PCT/GB06/02806

§ 371 Date: Jun. 27, 2008

(30) Foreign Application Priority Data
Jul. 27, 2005 (GB) 0515329.1

(51) Int. Cl. B32B 5/16; B01J 13/02

(52) U.S. Cl. 428/402.21; 264/4

(57) ABSTRACT

There is provided a method of forming a barrier over a polar liquid phase or a non-polar liquid phase including the steps of: providing a liquid system including the polar liquid phase or non-polar liquid phase and a monomer having a hydrophilic portion and a hydrophobic portion, monomer being located at one or more boundaries of the polar liquid phase or non-polar liquid phase; and polymerising the monomer so as to form a polymeric barrier at the one or more boundaries.

This invention relates to methods of forming a barrier, in particular a polymeric barrier, over a polar liquid phase or a non-polar liquid phase. Particular, but by no means exclusive, reference is made to encapsulation and the production of membranes.

Encapsulation, often referred to as micro encapsulation, is a well known process by which small amounts of a gas, liquid or solid are encapsulated within a shell material in order to shield the encapsulated substance. The contents of the capsule can be released at a later time by various means that are well known in the art, such as mechanical rupture of the capsule wall, or melting of the capsule wall. The contents of the capsule may be or contain an active ingredient which provides an advantageous effect in the application area envisaged. For example, perfume filled micro capsules are coated onto paper in scratch and -sniff perfume advertisements. The scratching of the paper acts to rupture the walls of the capsule, thereby releasing the perfumes. Other exemplar application areas for capsules of the type described above include enzyme encapsulation, for example in powered detergents, pharmaceutical applications, such as drug release, and also the encapsulation of adhesives, agro chemicals, flavours and catalysts. To date, most activity has been directed towards the encapsulation of non-polar materials. There would be considerable interest in the provision of encapsulation systems which can encapsulate polar substances, in particular water.

The present invention provides convenient and effective encapsulation systems which can encapsulate polar liquids such as water. Other systems falling within the ambit of the invention are capable of encapsulating non-polar liquids. The invention also enables the formation of other forms of barriers, such as membranes.

According to a first aspect of the invention there is provided a method of forming a barrier over a polar liquid phase or a non-polar liquid phase including the steps of providing a liquid system including the polar liquid phase or non-polar liquid phase and a monomer having a hydrophilic portion and a hydrophobic portion, monomer being located at one or more boundaries of the polar liquid phase or non-polar liquid phase; and

polymerising the monomer so as to form a polymeric barrier at the one or more boundaries.

The method of the invention includes embodiments in which a spray of the polar liquid phase or non-polar liquid phase and the monomer is provided. A co-extrusion encapsulation process may be employed, for example a process in which concentric orifices are provided, with the polar liquid or non-polar liquid phase flowing through one orifice and the monomer flowing through the other orifice. Preferably, the polar liquid phase or non-polar liquid phase flows through the central orifice of the concentric orifices. In this way, droplets of a polar liquid phase or a non-polar liquid phase can be provided which are surrounded by the monomer. The monomer is subsequently polymerised, thereby encapsulating the polar liquid or non-polar liquid phase.

According to a preferred aspect of the invention there is provided a method of forming a barrier between a polar liquid phase and a non-polar liquid phase including the steps of:

providing a liquid system including the polar liquid phase, the non-polar liquid phase and a monomer having a hydrophilic portion and a hydrophobic portion, monomer being located at one or more boundaries between the polar liquid phase and the non-polar liquid phase; and

polymerising the monomer so as to form a polymeric barrier between the polar liquid phase and the non-polar liquid phase.

Preferably, the polar liquid phase is aqueous, although other polar liquid phases, such as dimethyl sulphoxide (DMSO) might be used. The non-polar liquid phase may be an organic liquid, preferably a liquid hydrocarbon. The liquid hydrocarbon may be an alkane, preferably a straight chain alkane.

Encapsulation of the non-polar liquid phase may be accomplished by polymerising the monomer so as to produce a plurality of capsules. The term “capsules” as used herein includes within its scope shapes other than substantially spherical capsules, such as substantially cylindrical or “sausage shaped” capsules.

Encapsulation of the polar liquid phase may be accomplished by polymerising the monomer so as to produce a plurality of capsules.

Microencapsulation may be accomplished so as to produce a plurality of microcapsules. The microcapsules may be in the size range 1-100 μm. Either the polar liquid phase or the non-polar liquid phase may be microencapsulated. Alternatively, smaller or larger capsules may be produced. Nanoencapsulation is possible.

At least one of the non-polar liquid phase and the polar liquid phase may contain an additive. More than one additive may be present in a phase.

The nature of the additive is not limited, but in preferred embodiments the polar liquid phase is encapsulated and incorporates an anti-microbial agent, or a perfume, or a bleach.

In encapsulation embodiments of the invention, the step of providing a liquid system may include providing (a) a dispersion within the polar liquid phase of droplets of the non-polar liquid phase encapsulated by the monomer, or (b) a dispersion within the non-polar liquid phase of droplets of the polar liquid phase encapsulated by the monomer.

In encapsulation embodiments of the invention, the method may include the step of removing the capsules from the liquid system.

In alternative embodiments, the monomer is polymerised so as to form a membrane between the non-polar liquid phase and the polar liquid phase. In these instances, the step of providing a liquid system may include providing a volume of the polar liquid phase and a volume of the non-polar liquid phase and locating the monomer at an interface between said volume of polar liquid phase and said volume of non-polar liquid phase. A substantially flat membrane may be formed using volumes of polar liquid phase and non-polar liquid phase which are still.

A preferred class of monomer is given by quaternary amines, which may be dienyl quaternary amines.

A preferred class of monomer comprises a group of sub-formula (I)

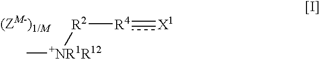

where R² and R³ are independently selected from (CR⁷R⁸)ₙ, or a group CR⁹R¹⁰, CR⁷R⁸CR⁹R¹⁰ or CR⁹R¹⁰CR⁷R⁸ where n is 0, 1 or 2, R⁷ and R⁸ are independently selected from hydrogen, halo or hydrocarbyl, and either one of R⁹ or R¹⁰ is hydrogen and the other is an electron withdrawing group, or R⁹ and R¹⁰ together form an electron withdrawing group, and

R⁴ and R⁵ are independently selected from CH or CR¹¹ where R¹¹ is an electron withdrawing group;

the dotted lines indicate the presence or absence of a bond, X¹ is a group CX²X³ where the dotted line bond to which it is attached is absent and a group CX² where the dotted line bond to which it is attached is present, Y¹ is a group CY²Y³ where the dotted line bond to which it is attached is absent and a group CY² where the dotted line bond to which it is attached is present, and X², X³, Y² and Y³ are independently selected from hydrogen, fluorine or other substituents;

R¹ is selected from hydrogen, halo, nitro, or hydrocarbyl, optionally substituted or interposed with functional groups;

R¹² is selected from hydrogen, halo, nitro, hydrocarbyl, optionally substituted or interposed with functional groups, or —R³—R⁵ [symbol] Y¹; and

Z is an anion of charge m.

International publications WO 00/06610, WO 00/06533, WO 00/06658, and WO 01/40874, and WO 01/74919, the contents of all of which are herein incorporated by reference, disclose polymers of the dienyl type, corresponding monomers, and methods for preparing the polymers and monomers. International Publication WO 01/74919 also discloses polymers formed from quaternary ammonium species having a single vinyl type group However, these publications do not even suggest that polymeric barriers of the type described herein might be contemplated.

As used herein, the expression “in the substantial absence of solvent” means that there is either no solvent present or there is insufficient solvent present to completely dissolve the reagents, although a small amount of a diluent may be present to allow the reagents to flow.

Conditions under which polymerisation occurs include the influence of radiation or an electron beam, or the presence of a chemical initiator. Radiation or electron beam induced polymerisation is suitably effected in the substantial absence of a solvent.

Preferably, R⁷ and R⁸ are independently selected from fluoro, chloro or alkyl or H. In the case of alkyl, methyl is most preferred.

It is possible that at least one, and possibly all, of X², X³, Y² and Y³ is a substituent other than hydrogen or fluorine. Preferably at least one, and possibly all, of X², X³, Y² and Y³ is an optionally substituted hydrocarbyl group. In such embodiments, it is preferred that at least one, and most preferably all, of X², X³, Y² and Y³ is an optionally substituted alkyl group. Particularly preferred examples are C₁ to C₄ alkyl groups, especially methyl or ethyl. Alternatively, at least one, and preferably all, of X², X³, Y² and Y³ are aryl and/or heterocyclic, such as pyridyl, pyrimidinyl, or a pyridine or pyrimidine containing group.

In preferred embodiments, X¹ and Y¹ are groups CX² X³ and CY¹Y² respectively and the dotted lines represent an absence of a bond. Thus preferred compounds are those of sub-formula (IA)

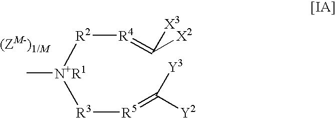

where R¹, R², R³, R⁴, R⁵, R⁶, X², X³, Y² and Y³ are as defined above. One or more such starting materials may be polymerised together. When more than one starting material is used, a copolymer will result.

When the dotted bonds in sub formula (I) are present, the resulting polymer will comprise polyacetylene chains. This can lead to a conjugated system and consequently a conducting polymer.

Suitably the starting material is one which will cyclopolymerise in the sort of conditions used in polymer production. This may comprise the application of radiation, such as UV radiation, where necessary in the presence of a photoinitiator, the application of heat (which may be in form of IR radiation), where necessary in the presence of an initiator, by the application of other sorts of initiator such as chemical initiators, or by initiation using an electron beam. The expression “chemical initiator” as used herein refers to compounds which can initiate polymerisation such as free radical initiators and ion initiators such as cationic or anionic initiators as are understood in the art.

Preferably, the starting materials polymerise under the influence of ultraviolet radiation or both. Cyclopolymerisation may take place either spontaneously or in the presence of a suitable initiator. Examples of suitable initiators include 2,2′-azobisisobutyronitrile (AIBN), aromatic ketones such as benzophenones in particular acetophenone; chlorinated acetophenones such as di- or tri-chloracetophenone; dialkoxyacetophenones such as dimethoxyacetophenones (sold under the trade name “Irgacure 651”) dialkylhydroxyacetophenones such as dimethylhydroxyacetophenone (sold under the trade name “Darocure 1173”); substituted dialkylhydroxyacetophenone alkyl ethers such as compounds of formula

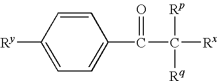

where R^{y} is alkyl and in particular 2,2-dimethylethyl, R^{x} is hydroxyl or halogen such as chloro, and R^{p} and R^{q} are independently selected from alkyl or halogen such as chloro (examples of which are sold under the trade names “Darocure 1116” and “Trigonal P1”); 1-benzoylcyclohexanol-2 (sold under the trade name “Irgacure 184”); benzoin or derivatives such as benzoin acetate, benzoin alkyl ethers in particular benzoin butyl ether, dialkoxybenzoins such as dimethoxybenzoin or deoxybenzoin; dibenzyl ketone; acyloxime esters such as methyl or ethyl esters of acyloxime (sold under the trade name, “Quantaqure PDO”); acylphosphine oxides, acylphosphonates such as dialkylacylphosphonate, ketosulphides for example of formula

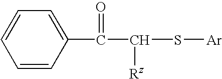

where R^{z} is alkyl and Ar is an aryl group; dibenzoyl disulphides such as 4,4′-dialkylbenzoyldisuphide; diphenyldithiocarbonate; benzophenone; 4,4′-bis(N,N-dialkyamino)benzophenone; fluorenone; thioxanthone; benzil; or a compound of formula

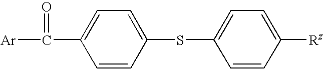

where Ar is an aryl group such as phenyl and R^{z} is alkyl such as methyl (sold under the trade name “Speedcure BMDS”).

As used herein, the term “alkyl” refers to straight or branched chain alkyl groups, suitably containing up to 20 and preferably up to 6 carbon atoms. The term “alkenyl” and “alkynyl” refer to unsaturated straight or branched chains which include for example from 2-20 carbon atoms, for example from 2 to 6 carbon atoms. Chains may include one or more double to triple bonds respectively. In addition, the term “aryl” refers to aromatic groups such as phenyl or naphthyl.

The term “hydrocarbyl” refers to any structure comprising carbon and hydrogen atoms. For example, these may be alkyl, alkenyl, alkynyl, aryl such as phenyl or napthyl, arylalkyl, cycloalkyl, cycloalkenyl or cycloalkynyl. Suitably they will contain up to 20 and preferably up to 10 carbon atoms. The term “heterocylyl” includes aromatic or non-aromatic rings, for example containing from 4 to 20, suitably from 5 to 10 ring atoms, at least one of which is a heteroatom such as oxygen, sulphur or nitrogen. Examples of such groups include furyl, thienyl, pyrrolyl, pyrrolidinyl, imidazolyl, triazolyl, thiazolyl, tetrazolyl, oxazolyl, isoxazolyl, pyrazolyl, pyridyl, pyrimidinyl, pyrazinyl, pyridazinyl, triazinyl, quinolinyl, isoquinolinyl, quinoxalinyl, benzthiazolyl, benzoxazolyl, benzothienyl or benzofuryl.

The term “functional group” refers to reactive groups such as halo, cyano, nitro, oxo C(O)ₙR^{a}, OR^{a}, S(O)ₜR^{a}, NR^{b}R^{c}, OC(O)NR^{b}R^{c}, C(O)NR^{b}R^{c}, OC(O) NR^{b}R^{c}, —NR⁷C(O)ₙR⁶, —NR^{a}CONR^{b}R^{c}, C═NOR^{a}, —N═C R^{b}R^{c}, S(O)ₜNR^{b}R^{r}, C(S)ₙR^{a}, C(S)OR^{a}, C(S)NR^{b}R^{c} or —NR^{b}S(O)ₜR^{a} where R^{a}, R^{b} and R^{c} are independently selected from hydrogen or optionally substituted hydrocarbyl, or R^{b} and R^{c} together form an optionally substituted ring which optionally contains further heteroatoms such as S(O)ₛ, oxygen and nitrogen, n is an integer of 1 or 2, t is 0 or an integer of 1-3. In particular the functional groups are groups such as halo, cyano, nitro, oxo, C(O)NR^{a}, OR^{a}, S(O)ₜR^{a}, NR^{b}R^{c}, OC(O)NR^{b}R^{c}, C(O)NR^{b}R^{c}, OC(O)NR^{b}R^{c}, —NR⁷C(O)ₙR⁶, —NR^{a}CONR^{b}R^{c}, —NR^{a}CSNR^{b}R^{c}, C═NOR^{a}, —N═CR^{b}R^{c}, S(O)ₜNR^{b}R^{c}, or —NR^{b}S(O)ₜR^{a} where R^{a}, R^{b} and R^{c}, n and t are as defined above.

The term “heteroatom” as used herein refers to non-carbon atoms such as oxygen, nitrogen or sulphur atoms. Where the nitrogen atoms are present, they will generally be present as part of an amino residue so that they will be substituted for example by hydrogen or alkyl.

The term “amide” is generally understood to refer to a group of formula C(O)NR^{a}R^{b} where R^{a} and R^{b} are hydrogen or an optionally substituted hydrocarbyl group. Similarly, the term “sulphonamide” will refer to a group of formula S(O)₂NR^{a}R^{b}.

The nature of any electron withdrawing group or groups additional to the amine moiety used in any particular case will depend upon its position in relation to the double bond it is required to activate, as well as the nature of any other functional groups within the compound. The term “electron withdrawing group” includes within its scope atomic substituents such as halo, e.g. fluoro, chloro and bromo.

Where R¹¹ is an electron withdrawing group, it is suitably acyl such as acetyl, nitrile or nitro.

Preferred anions Z^{m-} are halide ions, a boride ion, PF₆⁻, or a carboxylic acid ester anion.

Preferably X¹, X², Y¹ and Y² are all hydrogen.

Suitable groups R^{a} include hydrogen or methyl, in particular hydrogen.

A preferred group of the compounds for use in the method of the invention is a compound of structure (II)

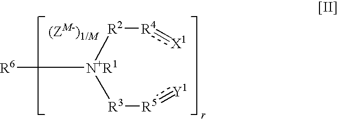

and in particular a compound of formula (IIA)

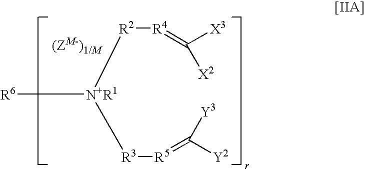

Where X¹, X², X³, Y¹, Y², Y³, R², R³, R⁴, R⁵ and the dotted bonds are as defined in relation to formula (I) above, r is an integer of 1 or more, and R⁶ is a bridging group, an optionally substituted hydrocarbyl group, a perhaloalkyl group, a siloxane group or an amide, of valency r.

Where in the compound of formula (II) and (IIA), r is 1, compounds can be readily polymerised to form a variety of polymer types depending upon the nature of the group R⁶. Embodiments in which r is 1 are most preferred, since it is easier to produce a molecule having discrete hydrophobic and hydrophilic regions capable of residing at the boundary between the polar and non-polar liquid phases. Monomers of this type may be represented as structure (III)

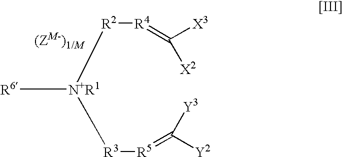

where X², X³, Y², Y³, R², R³, R⁴, and R⁵ are as defined in relation to formula (I) above, R^{6′} is an optionally substituted hydrocarbyl group, a perhaloalkyl group, a siloxane group or an amide.

The invention may also be applied to other sorts of polymers; for example, where in the compounds of formula (II), r is greater than one, polymerisation can result in polymer networks. Particular examples are compounds of formula (II) as defined above, where R⁶ is a bridging group and r is an integer of 2 or more, for example from 2 to 8 and preferably from 2-4.

On polymerisation of these such compounds, networks are formed whose properties maybe selected depending upon the precise nature of the R⁶ group, the amount of chain terminator present and the polymerisation conditions employed. Examples of bridging groups can be found in WO 00/06610. The use of compounds in which r is greater than three is less preferred since in general it is more difficult to provide monomers and corresponding polymers having a hydrophilic head region and a hydrophobic tail region. However, embodiments in which r is two are preferred. Without wishing to be bound by any particular theory, it is believed that compounds in which r is two can adopt a somewhat bent conformation in which both hydrophilic head regions can be located at a boundary, with a hydrophobic “tail region” linking the hydrophilic head regions and depending therefrom. R⁶ moieties having a degree of conformational flexibility are particularly preferred.

R⁶ or R^{6′} may comprise a straight or branched chain alkyl group, optionally substituted or interposed with functional groups.

R⁶ or R^{6′} may be an optionally substituted hydrocarbyl group having four or more carbon atoms, which may be an alkyl group, preferably a straight chain alkyl group. Monomers of this type can act as effective monomeric detergents, having affinity for both polar and non-polar phases. R⁶ or R^{6′} may have between five and twenty carbon atoms, preferably between eight and fourteen carbon atoms, most preferably ten carbon atoms. In a particularly preferred embodiment, the starting material is a compound of formula (IV)

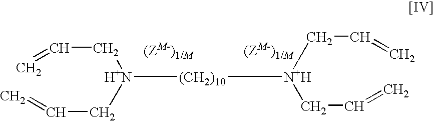

In another embodiment, the starting material is a compound of formula (v)

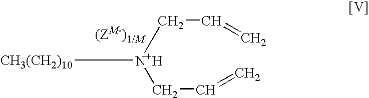

In embodiments in which R¹ is not —R³—R⁵ [symbol] Y¹, the monomer is preferably of the following formula

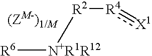

where R⁶ is as previously defined and may be a group R^{6′} as previously defined.

R¹ may be H or an alkyl group, preferably having less than 3 carbon atoms, most preferably methyl. When R¹ is alkyl, an enhanced detergent effect can result.

Preferably the step of polymerising the monomer produces a homopolymer. Alternatively the step of polymerising the monomer may produce a copolymer in which instance the step of providing a liquid system may comprise providing monomers having different monomeric units. A cross-linker moiety may be employed.

According to a second aspect of the invention there is provided a barrier obtained by a method according to the first aspect of the invention.

According to a third aspect of the invention, there is provided a capsule obtained by a method according to the first aspect of the invention.

According to a fourth aspect of the invention there is provided a membrane obtained by a method according to the first aspect of the invention.

According to a fifth aspect of the invention there is provided a barrier formed by the polymerisation of a monomer as defined in the first aspect of the invention.

According to a sixth aspect of the invention there is provided a capsule including a polar liquid phase or a non-polar liquid phase encapsulated within a polymeric barrier, wherein the polymeric barrier is formed by the polymerisation of a monomer as defined in the first aspect of the invention.

According to a seventh aspect of the invention there is provided a membrane formed by the polymerisation of a monomer as defined in the first aspect of the invention.

Whilst the invention has been described above, it extends to any inventive combination on sub-combination of the features set out above or in the following description or claims.

### EXAMPLE 1

A generic encapsulation experiment is described. Appropriate amounts of a liquid paraffin (e.g. 15 ml), water (e.g. 0.5 ml) and monomer (e.g. 5 ml) containing an appropriate amount of a photo initiator (e.g. 3 percent by weight Irgacure 184 photoinitiator) are provided. The water and the monomer are mixed together in a test tube. The mixing can take place at a temperature above ambient, for example ca. 35° C. so that the monomer is less viscous. The mixture of the water and the monomer is mixed with the liquid paraffin in a test tube. The test tube is shaken, stirred or otherwise agitated until an emulsion is formed. Typically agitation for ca. 10 seconds is sufficient. The emulsion is poured into a petrie dish to obtain a thin layer, approximately 1-3 mm thick. Curing is then performed using UV radiation, after which the capsules thus formed are filtered from the liquid paraffin, for example using a Whatman filter paper. The capsules are washed with iso-propyl alcohol (IPA) or hexane.

### EXAMPLE 2

A generic membrane forming process as described. Appropriate amounts of liquid paraffin (e.g. 15 ml), water (e.g. 15 ml) and monomer (e.g. 5 ml) containing a photoinitiator (e.g. containing 3 percent by weight of Irgacure 184 photoinitiator) are provided. The water is poured into a dish to form an aqueous layer. Onto the aqueous layer is poured the monomer to form a monomeric layer, and onto the monomeric layer is poured the liquid paraffin. The monomeric layer is cured by appropriate exposure to UV radiation to form a polymeric membrane located between the aqueous and paraffin layers. The polymeric membrane and/or the liquid layers are subsequently removed. By appropriate variation of the amount of monomer provided in relation to the surface area of the dish, it is possible to control the thickness of the membrane.

### EXAMPLE 3

The target molecule 1 is shown below.

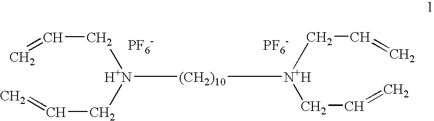

A mixture of 1,10-dibromodecane (23.8 g), diallylamine (15.4 g) and K₂CO₃ (58.0 g) in absolute ethanol were refluxed overnight with a drying arm over the condenser. Reaction progress was checked using TLC. Solid KBr and excess K₂CO₃ were removed from the solvent by filtration. Ethanol was removed by rotary evaporation together with any remaining diallylamine. Any solid KBr appearing at this point in the synthesis can be dissolved in dichloromethane (DCM) and filtered. Monomers obtained using dry silica gel flushed through with dry DCM. To a solution of monomer in methanol or dry DCM, a 6M aqueous solution of hydroperfluoric acid (HPF₆) is added until the mixture reaches a pH of about 5-6. The water is allowed to evaporate, leaving a quaternary amine.

### EXAMPLE 4

Step 1: To the quaternary amine 1 prepared in Example 3, 3 wt % of Irgacure 184 photoinitiator is added and dissolved by gentle heating (at ca. ° C.) and mixing using a whilimixer. Then, approximately 15 wt % of deionised water is added and dissolved in the same manner (note that alternative polar liquids to be encapsulated can be added at this stage instead of deionised water).

Step 2: Liquid paraffin is then added to the amine-1-initiator water solution in an approximate 5:1 ratio (paraffin:monomer mixture) by weight and an emulsion formed by vigorous mixing, done by heating the mixture to ca. 35° C. and mixing for 10 secs using a whilimixer.

Step 3: Immediately after the emulsion was prepared, the emulsion was poured into a dish (such as a petrie dish) to obtain a thin layer approx 1-3 mm thick. Curing was performed by exposing the layer to the UV radiation to form solid capsules in the liquid paraffin. Exposure times depend on the UV radiation source and exposure conditions: in this instance exposure involved two passes each of ˜1 sec to a 600 W/cm Ga doped mercury UV source.

Step 4: The capsules thus formed were filtered from the liquid paraffin using Whatman filter paper and any remaining paraffin was washed away using a suitable organic solvent such as IPA or hexane. Drying in the open air left the capsules of deionised water.

Identical results were obtained when the liquid paraffin was substituted by mineral oil using the same weight ratio with respect to the monomer.

### EXAMPLE 5

The target molecule 2 is shown below.

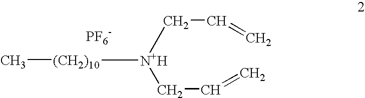

The synthesis described above in Example 3 was performed, except that 18.7 g of 1-bromoundecane, 7.7 g of diallylamine and 38.5 g of K₂ CO₃ were utilised.

### EXAMPLE 6

Freshly distilled diallylamine (67 g, 0.69 moles) was added to dry absolute ethanol (100 ml) and dry K₂CO₃ (270 g, 4.14 moles) and stirred for half an hour. 1,10-dibromodecane (100 g, 0.33 moles) was then added and the mixture was left to reflux for 96 hours. After cooling to room temperature, solids were filtered off. Remaining diallylamine and alcohol were then removed in vacuo. 100 ml of dichloromethane was added to this solution and any further precipitation was removed by filtration. The resulting diamine product and dichloromethane were then washed once in water and then brine and the aqueous phase removed. The mixture was then further dried using molecular sieves (4 A) and then the dichloromethane removed in vacuo. The product was purified further by column chromatography using silica and dichloromethane to produce a clear oil after removal of the dichloromethane. (Yield 65%)

Conversion to H Quaternary Ammonium Monomer

Quaternisation to produce a salt with an inorganic anion was performed by the addition of a concentrated inorganic acid, in aqueous or alcoholic solution, to the diamine in 2-propanol until the mixture reached slight acidity. The solution was then dried using molecular sieves (4 Å) and the 2-propanol then removed in vacuo. Using a similar method organic acids were added to make the organic salt using approximately a very slight stoichiometric excess of the organic acid. The target molecule 1 was prepared in this way.

Conversion to Methyl Quaternary Ammonium Iodide

To the diamine a slight excess of methyl iodide was added in dichloromethane and the mixture refluxed for 6 hours. Any methyl iodide and dichloromethane were removed in vacuo and the product then washed in dichloromethane and brine twice before being dried over dry molecular sieves (4 Å). The diiodomethane was removed in vacuo to afford an off white solid. (Yield 96%)

Monomers prepared using the methodology of Example 6 were polymerised according to Example 4.

### EXAMPLE 7

In further encapsulation experiments, bleaches, peracetic acid (35% solution in water), boric acid (25% solution in water) and sodium hypochlorite (5% solution in water) were encapsulated using the methodologies described in Examples 1, 4 and 6. In all cases the solution payload made up 20% of the total weight of the capsules, with the monomer/polymer making up the balance. Target molecule 1, together with monomers in which the PF₆⁻ anion was substituted with CI⁻ and I⁻, were utilised.

1-46. (canceled)

47. A method of forming a barrier over a polar liquid phase or a non-polar liquid phase including the steps of:
providing a liquid system including the polar liquid phase or non-polar liquid phase and a monomer having a hydrophilic portion and a hydrophobic portion, monomer being located at one or more boundaries of the polar liquid phase or non-polar liquid phase; and
polymerising the monomer so as to form a polymeric barrier at the one or more boundaries.

48. A method according to claim 47 in which a barrier is formed between the polar liquid phase and the non-polar liquid phase, wherein monomer is located at one or more boundaries between the polar liquid phase and the non-polar liquid phase; and the monomer is polymerised so as to form a polymeric barrier between the polar liquid phase and the non-polar liquid phase.

49. A method according to claim 47 in which the polar liquid phase is aqueous.

50. A method according to claim 47 in which the non-polar liquid phase is an organic liquid.

51. A method according to claim 50 in which the organic liquid is a liquid hydrocarbon.

52. A method according to claim 51 in which the liquid hydrocarbon is an alkane.

53. A method according to claim 52 in which the alkane is a straight chain alkane.

54. A method according to claim 47 in which encapsulation of the non-polar liquid phase Is accomplished by polymerising the monomer so as to produce a plurality of capsules.

55. A method according to claim 47 in which encapsulation of the polar liquid phase is accomplished by polymerising the monomer so as to produce a plurality of capsules.

56. A method according to claim 47 in which microencapsulation is accomplished so as to produce a plurality of microcapsules.

57. A method according to claim 55 in which the polar liquid phase incorporates an anti-microbial agent.

58. A method according to claim 55 in which the polar liquid phase incorporates a perfume.

59. A method according to claim 54 in which the step of providing a liquid system includes providing (a) a dispersion within the polar liquid phase of droplets of the non-polar liquid phase encapsulated by the monomer, or (b) a dispersion within the non-polar liquid phase of droplets of the polar liquid phase encapsulated by the monomer.

60. A method according to claim 47 in which the monomer is polymerised so as to form a membrane between the non-polar liquid phase and the polar liquid phase.

61. A method according to claim 60 in which the step of providing a liquid system includes providing a volume of the polar liquid phase and a volume of the non-polar liquid phase, and locating the monomer at an interface between said volume of polar liquid phase and said volume of non-polar liquid phase.

62. A method according to claim 47 in which the monomer is a quaternary amine.

63. A method according to claim 62 in which the monomer is a dienyl quaternary amine.

64. A method according to claim 62 in which the monomer comprises a group of sub-formula (I) 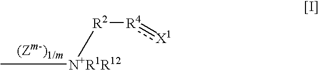
where R² and R³ are independently selected from (CR⁷R⁸)ₙ, or a group CR⁹R¹⁰, CR⁷R⁸CR⁹R⁹R¹⁰ or CR⁹R¹⁰CR⁷CR⁸ where n is 0, 1 or 2, R⁷ and R⁸ are independently selected from hydrogen, halo or hydrocarbyl, and either one of R⁹ or R¹⁰ is hydrogen and the other is an electron withdrawing group. or R⁹ and R¹⁰ together form an electron withdrawing group, and
R⁴ and R⁵ are independently selected from CH or CR¹¹ where R¹¹ is an electron withdrawing group;
the dotted lines indicate the presence or absence of a bond, X¹ is a group CX²X³ where the dotted line bond to which it is attached is absent and a group CX² where the dotted line bond to which it is attached is present, Y¹ is a group CY²Y³ where the dotted line bond to which it is attached is absent and a group CY² where the dotted line bond to which it is attached is present, and X², X³, Y² and Y³ are independently selected from hydrogen, fluorine or other substituents;
R¹ is selected from hydrogen, halo, nitro, or hydrocarbyl, optionally substituted or interposed with functional groups;
R¹² is selected from hydrogen, halo, nitro, hydrocarbyl, optionally R3 5 1 substituted or interposed with functional groups, or —R³—R⁵ [symbol] Y¹; and
Z is an anion of charge m.

65. A method according to claim 20 wherein the group of sub-formula (I) is a group of sub-formula (IA) 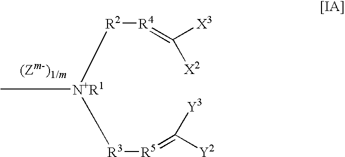
where R², R³, R⁴, R⁵, X², X³, Y² and Y³ are as defined in claim 64.

66. A method according to anyone of claim 64 wherein the polymerisation of the monomer is effected by the application of ultraviolet radiation, where necessary in the presence of an initiator.

67. A method according to anyone of claim 64 wherein Z^{m-} is a halide ion, a boride ion, PF₆⁻ or a carboxylic acid ester.

68. A method according to claim 64 where, in the group of sub-formula (I), X¹ and Y¹ represent CX²X³ and CY²Y³ respectively, the dotted bonds are absent and X¹, X², Y¹ and Y² are all hydrogen.

69. A method according to claim 64 wherein the starting material is a compound of structure (II) 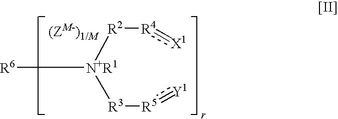
where X¹, Y¹, R², R³, R⁴, R⁵ and the dotted bonds are as defined in claim 64, r is an integer of 1 or more, and R⁶ is a bridging group, an optionally substituted hydrocarbyl group a perhaloalkyl group, a siloxane group, or an amide, of valency r.

70. A method according to claim 69 wherein the starting material comprises a compound of formula (III) 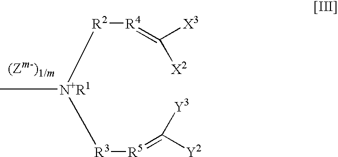
optionally substituted hydrocarbyl group, a perhaloalkyl group, a siloxane group or an amide.

71. A method according to claim 69 in which r is two.

72. A method according to claim 69 wherein R⁶ or R^{6′} comprises a straight or branched chain alkyl group, optionally substituted or interposed with functional groups.

73. A method according to claim 69 wherein R⁶ or R^{6′} is an optionally substituted hydrocarbyl group having four or more carbon atoms.

74. A method according to claim 73 in which R⁶ or R^{6′} is an alkyl group, preferably a straight chain alkyl group.

75. A method according to claim 74 in which R⁶ or R^{6′} has between five and twenty carbon atoms, preferably between eight and fourteen carbon atoms, most preferably ten carbon atoms.

76. A method according to claim 75 in which the starting material is a compound of formula (IV)

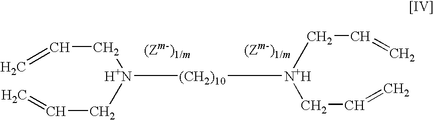

77. A method according to claim 35 in which the starting material is a compound of formula (V)

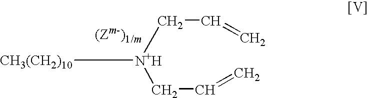

78. A method according to claim 64 in which R1 is H or an alkyl group, preferably having less than 3 carbon atoms, most preferably methyl.

79. A method according to claim 47 wherein the step of polymerising the monomer produces a homopolymer.

80. A method according to claim 47 wherein the step of polymerising the monomer produces a copolymer and wherein the step of providing a liquid system comprises providing monomers having different monomeric units.

81. A barrier obtained by a method according to claim 47.

82. A capsule obtained by a method according to claim 53.

83. A membrane obtained by a method according to claim 61.
